(19) United States
(12) Patent Application Publication
(10) Pub. No.: US 2002/0124565 A1
(43) Pub. Date: Sep. 12, 2002

(54) EGR system

(75) Inventor: Yukihiro Tsuji, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: HINO MOTORS LTD., Tokyo (JP)

(21) Appl. No.: 10/086,365

(22) Filed: Mar. 4, 2002

(30) Foreign Application Priority Data
Mar. 8, 2001 (JP) 2001-064923

(51) Int. Cl. F02B 33/44

(52) U.S. Cl. 60/605.2

(57) ABSTRACT

Disclosed is an exhaust gas recirculation (EGR) system which enables excellent recirculation of exhaust gas from an exhaust manifold to an intake pipe even in a high load zone of an engine equipped with a turbocharger. The EGR system is equipped with a generator coaxial with the turbine and installed between the compressor and turbine of the turbocharger such that an amount of electric power to be generated by the generator can be controlled.

### BACKGROUND OF THE INVENTION

1. Field of the Invention

The present invention relates to an exhaust gas recirculation (EGR) system.

2. Detailed Description of the Related Art

Conventionally, what is called exhaust gas recirculation (EGR) has been means for reducing NOₓ gas from, for example, an engine of an automobile. The EGR works such that a portion of exhaust gas from an exhaust side is returned to an intake side to suppress fuel combustion in the engine and lower combustion temperature so that the generation of NOₓ gas is reduced.

FIG. 1 shows an example of an EGR system for the recirculation of exhaust gas described above. In this figure, reference numeral 1 denotes a diesel engine. The engine 1 is equipped with a turbocharger 2 such that intake air 4 from an air cleaner 3 is sent via an intake pipe 5 to a compressor 2a of the turbocharger 2 and compressed by the compressor 2a. Then the intake air 4 is sent to an inter cooler 6 for cooling and further to an intake manifold 7 so that it is distributed to each of cylinders of the engine 1.

Further, it is so designed that exhaust gas 8 discharged from each of the cylinders of the engine 1 is sent via an exhaust manifold 9 to and drives a turbine 2b of the turbocharger 2 and the exhaust gas 8 and is discharged outside of the vehicle via an exhaust pipe 10.

Also, one end portion, in a direction of the row of cylinders, of the exhaust manifold 9 (an exhaust passage upstream of the turbine 2b) is connected via an EGR pipe 11 to one end portion of the intake pipe 5 (an intake passage downstream of the compressor 2a) led to the intake manifold 7. This makes it possible that a portion of the exhaust gas 8 is taken from the exhaust manifold 9 to the intake pipe 5.

The EGR pipe 11 is provided with an EGR valve 12 which selectively opens and closes the EGR pipe 11, and also with an EGR cooler 13 which cools the exhaust gas 8 to be recirculated. In the EGR cooler 13, heat exchange takes place between the exhaust gas 8 and cooling water to lower the temperature of the exhaust gas 8. This makes it possible that combustion temperature is lowered through recirculation of the water-cooled exhaust gas 8 to the engine 1.

However, a conventional EGR system as described above has a problem in that the exhaust gas 8 may fail to be recirculated from the exhaust manifold 9 to the intake pipe 5 since, as shown by cross-hatching in FIG. 2, an area of supercharged pressure created by the turbocharger 2 being higher than exhaust pressure is produced mainly in a high engine load zone.

### BRIEF SUMMARY OF THE INVENTION

The present invention was made in view of the above and has its object to provide an EGR system which enables excellent recirculation of exhaust gas from an exhaust manifold to an intake pipe even in a high load zone of an engine equipped with a turbocharger.

More specifically, the present invention provides an EGR system in an engine equipped with a turbocharger with a turbine and a compressor for recirculating a portion of exhaust gas from an exhaust passage upstream of the turbine to an intake passage downstream of the compressor, comprising a generator coaxial with the turbine and installed between the compressor and turbine of the turbocharger such that an amount of electric power to be generated by the generator can be controlled.

With this arrangement, a portion of exhaust gas taken from the exhaust manifold or exhaust passage upstream of the turbine is excellently recirculated to the intake pipe downstream of the compressor, in the following way. When the generator is operated in a high load zone where supercharged pressure from the turbocharger generally tends to be higher than exhaust pressure, the generator in operation acts as resistance to brake or apply braking torque on a turbine shaft of the turbocharger. This decreases efficiency of the turbocharger to lower supercharged pressure on the side of the compressor, and at the same time increases airflow resistance of exhaust gas to the turbine to raise the exhaust pressure at the upstream exhaust manifold. As a result, the exhaust pressure is maintained at a higher level than the supercharged pressure.

Further, in a low engine load zone where exhaust gas can be recirculated without any specific problem, an amount of electric power to be generated may be reduced to make the generator into a substantially inoperative state. Under such conditions, the turbine shaft of the turbocharger is not braked or has no braking torque applied, and therefore the turbocharger is driven with its original high efficiency.

When electric power generated by the generator is effectively used as part of electricity to be consumed by various kinds of electrical equipment, a burden of a power supply for such electrical equipment will be drastically reduced.

An embodiment of the invention will be described below with reference to the drawings.

### BRIEF DESCRIPTION OF THE DRAWINGS

FIG. 1 is a schematic view showing a conventional EGR system;

FIG. 2 is a graph illustrating an area of supercharged pressure being higher than exhaust pressure; and

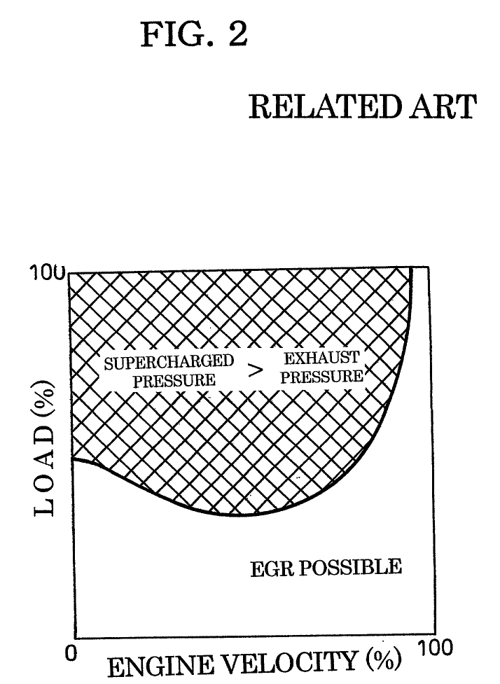

FIG. 3 is a schematic view of an embodiment according to the present invention.

### DETAILED DESCRIPTION OF THE PREFERRED EMBODIMENT

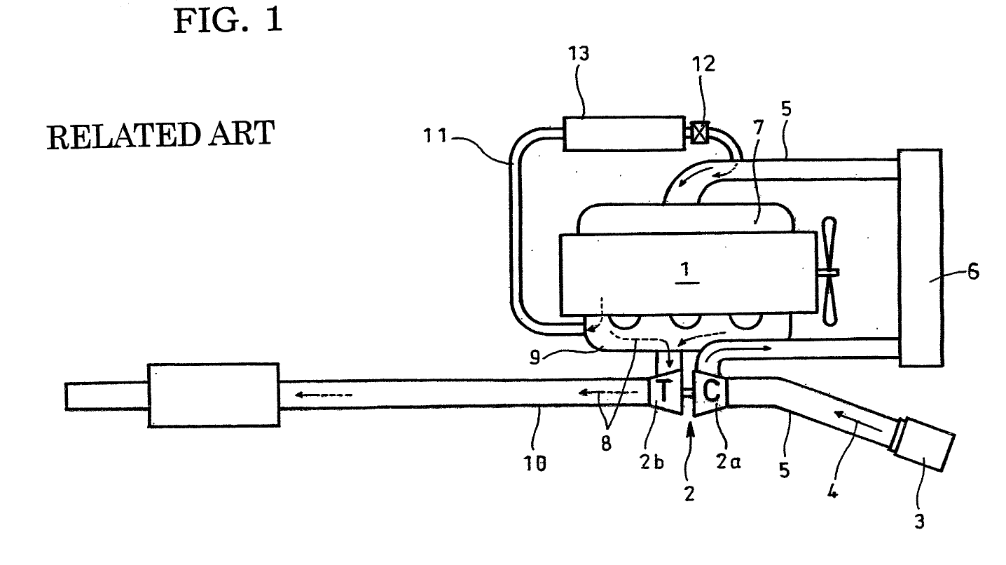

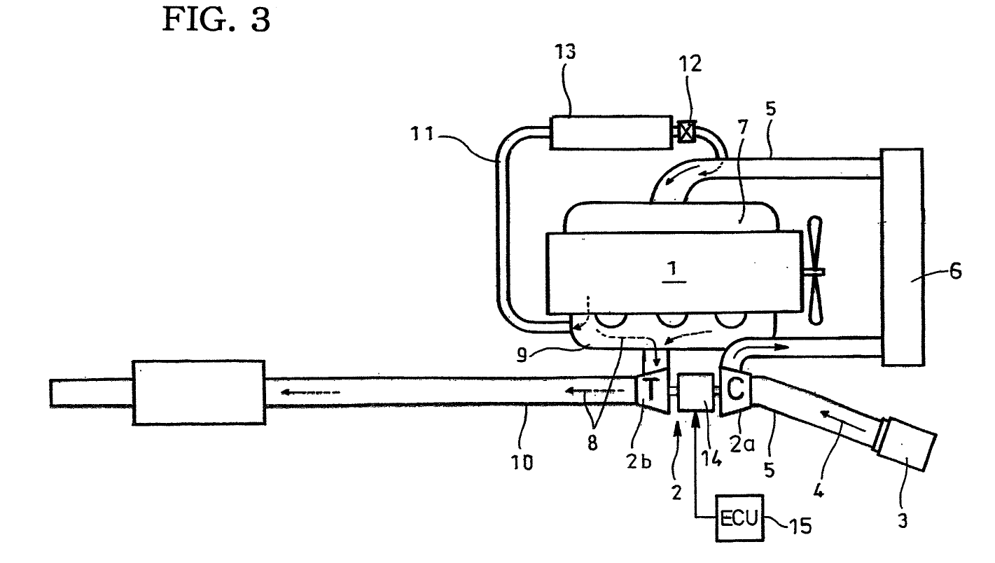

FIG. 3 shows an embodiment according to the present invention. In this figure, parts identical to those in FIG. 1 are given the same reference numerals.

In this embodiment, as shown in FIG. 3, a generator 14 coaxial with a turbine 2b is installed between a compressor 2a and the turbine 2b of a turbocharger 2. This equipment is so constituted that an amount of electric power to be generated by the generator 14 is controlled by power generation instructions from an ECU (engine control unit) or engine control computer 15.

In controlling the amount of electric power to be generated by the generator 14, for example, the generator 14 may be connected via an inverter with a regenerative converter to a battery (power supply) so that an amount of regenerative electric power to be returned to the battery may be increased or decreased by the inverter which is controlled by the engine control computer 15.

In recirculating a portion of exhaust gas 8 through an EGR pipe 11 with an EGR valve 12 being opened, the exhaust gas 8 is excellently recirculated from an exhaust manifold 9 to an intake pipe 5 in the following way. In a high engine load zone where supercharged pressure from the turbocharger 2 generally tends to be higher than exhaust pressure, the inverter is controlled through power generation instructions from the engine control computer 15 to increase an amount of regenerative power to be returned to the battery to thereby bring the generator 14 to operation. The generator 14 in operation then acts as resistance to brake or apply braking torque on a shaft of the turbine 2b of the turbocharger 2. This decreases efficiency of the turbocharger 2 to lower supercharged pressure on the side of the compressor 2a, and increases air-flow resistance of the exhaust gas 8 to the turbine 2b to raise exhaust pressure at the upstream exhaust manifold 9. As a result, exhaust pressure is maintained at a higher level than the charged pressure.

Information necessary for controlling the operation of engine 1, such as the number of revolution, load, an amount of air intake and supercharged pressure of the engine 1, is inputted into the engine control computer 15. Then, in accordance with current operating status judged from such information as mentioned above, a magnitude of load on the turbocharger 2 which is required to make exhaust pressure of the exhaust manifold 9 higher than supercharged pressure (intake pressure inside the intake pipe 5) is calculated. Subsequently, the amount of load calculated is converted into a calculated amount of electric power to be generated, and the latter is outputted as power generation instructions.

Further, in a low engine load zone where the exhaust gas 8 can be recirculated without any specific problem, the amount of electric power to be generated may be decreased to a level where regenerative electric power returned to the battery is close to zero. Then, with the generator 14 being in a substantially inoperative state, the regenerative power current may be returned to the generator 14. This prevents the shaft of the turbine 2b of the turbocharger 2 from being braked or having braking torque applied so that the turbocharger 2 is driven with its original high efficiency.

Therefore, according to the embodiment described above, even in a high load zone of the engine 1 equipped with the turbocharger 2, exhaust pressure can be maintained at a higher level than supercharged pressure since load on the turbine 2b of the turbocharger 2 through the operation of the generator 14 can decrease working efficiency of the turbocharger 2 to a desired level. Consequently, the exhaust gas 8 can be excellently recirculated from the exhaust manifold 9 to the intake pipe 5.

Further, as described above, electric power generated by the generator 14 may be returned via the inverter to the battery so as to effectively use the returned power as a portion of electric power to be consumed by various types of electrical equipment. Since this greatly reduces the burden on the power supply side with respect to such electrical equipment, load on an alternator which is an existing power generation facility installed on the engine 1 can be also reduced, which reduces a burden on the engine 1 imposed by the drive of the alternator so as to improve fuel economy of the engine 1.

Although the above description exemplifies a case in which electric power generated by the generator 14 is effectively used, it is also possible to lead regenerative electric power from the generator 14 to equipment such as variable resistor to have it consumed as heat instead of returning it to the battery.

It is to be understood that an EGR system according to the invention is not limited to the embodiment described above. For example, electric power generated by a generator may be not only used as power consumption for an engine control system but also effectively used as auxiliary power for various types of electrical equipment; also, exhaust gas may be taken from an exhaust pipe upstream of a turbine of a turbocharger; further, the exhaust gas taken may be returned to an intake manifold downstream of a compressor of the turbocharger.

What is claimed is:

1. An EGR system in an engine equipped with a turbocharger with a turbine and a compressor for recirculating a portion of exhaust gas from an exhaust passage upstream of the turbine to an intake passage downstream of the compressor, comprising a generator coaxial with the turbine and installed between the compressor and turbine of the turbocharger such that an amount of electric power to be generated by the generator can be controlled.
